(19) United States
(12) Patent Application Publication
(10) Pub. No.: US 2010/0295477 A1
(43) Pub. Date: Nov. 25, 2010

(54) METHOD FOR OPERATING A GAS DISCHARGE LAMP AND A GAS DISCHARGE LAMP DRIVER SYSTEM

(75) Inventor: Dolf Henricus Jozef Van Casteren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/517,814

(22) PCT Filed: Dec. 10, 2007
(86) PCT No.: PCT/IB2007/054983

§ 371 Date: Jun. 5, 2009

(30) Foreign Application Priority Data
Dec. 12, 2006 (EP) 06125941.2

(51) Int. Cl. H05B 41/36

(52) U.S. Cl. 315/307

(57) ABSTRACT

In a method and circuit for operating a gas discharge lamp, the physical processes occurring in the gas discharge lamp are determined in order to control the behavior, and thus the light output, of the gas discharge lamp. Thereto, the method comprises the steps of, and the circuit comprises means for, providing an operating current to the gas discharge lamp and determining an operating parameter of the gas discharge lamp. Based on the determined operating parameter a value of a physical lamp parameter of the gas discharge lamp is determined. Using the determined value of the physical lamp parameter and a corresponding mathematical model of a physical process occurring in the gas discharge lamp an operating state of the gas discharge lamp is estimated. Using the model, which is based on the physical principles of the processes occurring in the gas discharge lamp, it is possible to determine the physical state of the gas discharge lamp. Consequently the operating current supplied to the gas discharge lamp may be controlled based on the determined operating state of the gas discharge lamp.

### FIELD OF THE INVENTION

The present invention relates to a lamp driver system and a method for operating a lamp and in particular to a lamp driver system and method for operating a gas discharge lamp by controlling a lamp current.

### BACKGROUND OF THE INVENTION

In a gas discharge lamp, such as a high-pressure metal halide lamp, also known as a high intensity discharge (HID) lamp, electrical energy is transformed into visible and invisible electromagnetic radiation and heat. Properties of the output light, i.e. visible electromagnetic radiation, depend on the properties of the gas discharge lamp. For example, the physical processes generating the electromagnetic radiation occur in an enclosure. The enclosure, known in the art as the arc tube, may be a closed cylindrical container, in which two electrodes e.g. from tungsten, are positioned. The arc tube may be made of glass, quartz or ceramic. The arc tube is filled with a mixture of e.g. mercury, metal halides and/or an inert gas. Metal halides are compounds of metals and halogens. Introducing metal halides in a high-pressure mercury discharge lamp enhances the spectral quality and luminous efficiency. A ceramic discharge tube can be operated at higher temperatures compared to a quartz arc tube, thereby enabling higher vapor pressure and thus better properties of the output light.

The properties of the output light further depend on the electrodes. For example, the performance over the lifetime of metal halide lamps is strongly related to the performance of the electrodes over their lifetime.

A known lamp driver circuit for operating a HID lamp is based on feed-forward control. In such a feed-forward control method, no information on the actual state of the HID lamp is determined and used for control, but the specific HID lamp is assumed to have an average lamp behavior. However, as mentioned above, specific lamps have specific lamp behavior depending on the manufacturer, production spread, reduced power operation (dimming), and changes over lifetime, resulting in a wide spread in lamp parameter values. Feedback of actual behavior of the HID lamp, or any other gas discharge lamp, allows a better lamp current control. For lamp behavior control, the feedback should relate to at least one physical lamp parameter of a physical process occurring in the arc tube. A physical lamp parameter is, however, not directly observable or measurable.

In another known lamp operating method, as disclosed in Van Casteren, D. H. J. et al. Industry Applications Conference, 2005, 40th IAS Annual Meeting, Conference Record, Vol. 2, 2-6 Oct. 2005, p. 1182-1187), feedback control is employed. In the known method, however, the feedback control is based on operating lamp parameters, instead of the physical lamp parameters.

### OBJECT OF THE INVENTION

It is an object of the present invention to provide a lamp operating method and a lamp driver circuit for operating a gas discharge lamp, wherein an operating current is controlled based on actual physical lamp behavior.

### SUMMARY OF THE INVENTION

The object is achieved in a lamp operating method according to claim 1 and a lamp driver system according to claim 6.

In accordance with the present invention, an operating current is supplied to the gas discharge lamp. At least one operating parameter is determined, which operating parameter is an observable property of the operating lamp. For example, the operating parameter may be a discharge voltage resulting from the current flowing through the gas discharge lamp.

Using the determined operating parameter of the gas discharge lamp, a value of a physical lamp parameter is determined. The value of the physical lamp parameter provides information about a physical process occurring in the arc tube of the gas discharge lamp.

Then, using the value of the physical lamp parameter, or the value of a number of physical lamp parameters, and using a mathematical model of at least the above-mentioned physical process, the model comprising the physical lamp parameter, a state or condition of the gas discharge lamp may be determined. As mentioned above, the physical processes are influenced by a physical state of the arc tube, the electrodes and the chemical vapor mixture in the arc tube. Thus, the value of the physical lamp parameter is an indicator for a physical state of the gas discharge lamp. Therefore, based on the determined value of the physical lamp parameter and using a suitable model of the physical process, the physical state of the gas discharge lamp, or a part thereof, may be estimated, and thus determined.

Having determined the physical state of the gas discharge lamp, or part thereof, the lamp current supplied to the gas discharge lamp may be controlled such that the gas discharge lamp outputs a desired light, e.g. having a desired output level, a desired light color, or the like. Thus, the supplied current may be controlled in order to, for example, take into account a decreased efficiency of the visible radiation output. The determined physical state may be used to determine a minimum and/or a maximum dim level based on the physical state of the lamp. Further, the physical state may be used to obtain a stable discharge in the arc tube during steady state operation. Also other aspects and characteristics may be controlled, determined and/or taken into account.

The mathematical model of the physical process may be selected and/or developed in order to meet a desired control. A number of mathematical models are known from the prior art. For example, in “Physics based MATLAB model for ceramic metal halide lamps”, Van Casteren, D. H. J. et al. Industry Applications Conference, 2006, 41st IAS Annual Meeting, Conference Record, 8-12 Oct. 2006, discloses a method for obtaining the small-signal dynamic characteristics of metal halide lamps and discloses how to use the determined dynamic characteristics for improving the non-linear behavior of the lamp and improving the lamp-ballast performance. “Nonlinear high-intensity discharge lamp model including a dynamic electrode voltage drop”, Yan, W. et al., Science, Measurement and Technology, IEE Proceedings, Vol. 150, Issue 4, Jul. 3, 2003, p. 161-167 discloses a model based on the physical laws of plasma arc discharge including a voltage drop parameter. “An Equivalent Conductance Model for High Intensity Discharge Lamps”, Anton, J. C. et al., Industry Applications Conference, 2002, 37th IAS Annual Meeting, Conference Record, Vol. 2, 13-18 Oct. 2002, p. 1494-1498, discloses a mathematical model of a physical process in the gas discharge lamp based on lamp electrical conductance. “Modeling and control of automotive HID lamp ballast”, In-Kyu Lee, et al., Power Electronics and Drive Systems, 1999 (PEDS '99), Proceedings of the IEEE 1999 International Conference, Vol. 1, 27-29 Jul. 1999, p. 506-510 discloses an empirical modeling of a HID lamp and a small signal modeling of the lamp ballast. Thus, based on the desired control features, a suitable model may be selected from the above-mentioned or other prior art, or another model may be developed.

It is noted that in the above-mentioned disclosures reference is made to use of the models in ballast circuit design, i.e. lamp driving circuit design. None of the disclosures suggests implementing the model in a feedback circuit for real-time feedback control.

In an embodiment, the lamp driver system may comprise a user control device, using which a user may provide a user setting, such as a dim level, to the control system. The control system using the feedback control method according to the present invention may adjust the current supplied to the discharge lamp based on the determined physical state and the desired user setting.

In an embodiment, the lamp driver system may comprise a user control device and the control system may be configured to supply the determined physical state of the lamp to the control device. The physical state may comprise information about an expected remaining lifetime and/or a minimum dim level, for example. Based on such information, a user may decide to replace the gas discharge lamp, for example.

In an embodiment, the control system receives the determined lamp operating parameter and generates an estimated lamp operating parameter based on an earlier determined lamp operating parameter value or based on an average lamp operating parameter value. Using a suitable algorithm, the physical lamp parameter value is determined based on the determined lamp operating parameter value and the estimated lamp operating parameter value. For example, the estimated lamp operating parameter may be determined using an estimated physical lamp parameter. If a difference between the determined lamp operating parameter value and the estimated lamp operating parameter value is found to be zero, the estimated lamp operating parameter is found to be correct, and therefore the estimated physical lamp parameter value is correct. However, if said difference is not equal to zero, the estimated physical lamp parameter value may be adjusted, thereby adjusting of the lamp operating parameter value. Then, using the adjusted lamp operating parameter value, the difference may be determined again, and so on, until the difference becomes zero and thus obtaining a suitable estimated physical lamp parameter value.

In an embodiment, for determining the physical lamp parameter value, a method may be used, which is selected from the group comprising an adaptive algorithm, e.g. as above described, a run-up (and/or power) tracing method, a Pseudo Random Noise Sequence (PRNS) and any combination thereof. Also other suitable known methods for determining a parameter value may be employed.

In an embodiment, the control system comprises a memory and a microcontroller for determining the physical lamp parameter value. The memory, coupled to the microcontroller, comprises microcontroller executable instructions for instructing the microcontroller to determine the physical lamp parameter based on the received operating parameter and to determine the lamp operating state using the determined physical lamp parameter and using the corresponding model of the physical process of the gas discharge lamp. Commercially available microcontrollers have sufficient capacity to perform such calculations in realtime and thus, a flexible lamp driver system may be provided. In particular, if the memory is a rewritable memory, the instructions comprising the model may be replaced by another set of instructions allowing to reprogram the lamp driver system in order to employ another model. Therefore, the present invention further provides a computer program comprising microcontroller executable instructions for instructing the microcontroller to perform at least one of determining a physical lamp parameter value and determining a physical state of the lamp in accordance with an embodiment of the method of the present invention.

### BRIEF DESCRIPTION OF THE DRAWINGS

Hereinafter, the present invention is elucidated with reference to non-limiting embodiments as illustrated in the appended drawings, in which

FIG. 1 schematically illustrates a method and system according to an embodiment of the present invention.

### DETAILED DESCRIPTION OF EXAMPLES

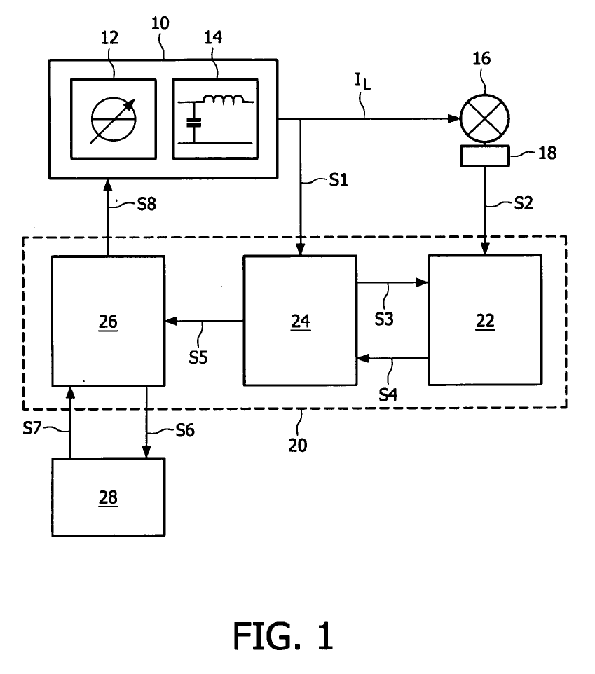

In FIG. 1 a lamp driver system for operating a gas discharge lamp 16 is schematically shown. The gas discharge lamp 16 may be a HID lamp such as a metal halide lamp, or may be a Ultra High Pressure (UHP) lamp or any other kind of gas discharge lamp. The lamp driver system comprises a lamp driver circuit 10, also known as a lamp ballast circuit, which may comprise a controllable current supply 12 and/or a resonant circuit 14. The lamp driver circuit 10 is configured to supply a suitable operating current I_{L} to the gas discharge lamp 16. The controllable current supply 12 may be a switched mode power supply, such as a buck converter, for example.

The lamp driver circuit 10 may further comprise an inverter circuit in a half-bridge or a full-bridge topology, for example, for supplying an alternating current. In such an embodiment, not only the supplied amount of current may be controllable, but also a frequency of the alternating current may be controllable.

The lamp driver system further comprises a sensing circuit 18 for sensing a lamp operating parameter value and a control system 20. In the illustrated embodiment, the control system 20 comprises a physical parameter estimation circuit 22, a physical state observer circuit 24 and a rule-based controller circuit 26. The rule-based controller circuit 26 is configured to supply a lamp driver control signal S8 to the lamp driver circuit 10 for controlling the operating current I_{L} in order to control the light output of the discharge lamp 16.

The sensing circuit 18 supplies a lamp operating parameter signal S2 to the physical parameter estimation circuit 22, which signal comprises a lamp operating parameter value. The physical parameter estimation circuit 22 uses the lamp operating parameter value for determining a physical lamp parameter value. Thereto, the physical parameter estimation circuit 22 may use an adaptive algorithm or may employ a dynamic identification and estimation method such as a run-up tracing method or a Pseudo Random Noise Sequence (PRNS) method, or any combination of such methods. The determined lamp operating parameter may for example be a lamp voltage induced by the supplied operating current I_{L} flowing through the discharge lamp 16. In an embodiment, the operating current I_{L} may be controlled to vary in order to determine a lamp voltage variation due to the operating current variation.

The physical parameter estimation circuit 22 may further be supplied with an estimated operating parameter signal S3, such as an estimated discharge voltage, if the determined operating parameter is the lamp voltage. The estimated operating parameter signal S3 may be output by the physical state observer circuit 24, which comprises a mathematical model of at least one physical process occurring in the discharge lamp 16. Such an estimation may be based on earlier determined lamp operating parameters and/or earlier determined physical lamp parameters and/or on predetermined average physical parameter values. For example, the physical parameter estimation circuit 22 may estimate the physical lamp parameter value based on a difference between the determined lamp operating parameter (lamp operating parameter signal S2) and the estimated lamp operating parameter (estimated operating parameter signal S3).

The physical parameter estimation circuit 22 outputs a physical parameter value as an estimated physical parameter signal S4, which is supplied to the physical state observer circuit 24. The physical state observer circuit 24 is provided with a mathematical model of at least one of the physical processes occurring in the discharge lamp 16, as mentioned above. The model comprises the physical lamp parameter, of which a value is unknown, until it is received from the physical parameter estimation circuit 22 as the estimated physical parameter signal S4. Using the mathematical model and the physical lamp parameter value the physical state observer circuit 24 determines the physical state of the discharge lamp 16. Thus, the actual physical state of the operating discharge lamp 16 is estimated using the mathematical model.

The determined physical state is output from the physical state observer circuit 24 as an estimated physical state signal S5. The physical state may comprise information about the physical state of the electrodes, an expected remaining lifetime, a minimum dim level, and the like. For example, the minimum dim level may change during the lifetime of the discharge lamp 16, e.g. due to changes in the electrodes. Therefore, the state observer circuit 24 may determine the actual minimum dim level for the discharge lamp 16 coupled to the lamp driver system such that the lamp driver system is capable to control the lamp to its minimum dim level without the possibility that the discharge lamp 16 will extinguish.

The control system 20 may comprise a rule-based controller circuit 26, as illustrated, but other kinds of controller circuits may as well be employed. The rule-based controller circuit 26 supplies the lamp driver control signal S8 to the lamp driver circuit 10 in order to control the operating current I_{L} corresponding to the physical state as determined by the physical state observer circuit 24.

Further, the rule-based controller circuit 26 may be coupled, e.g. wirelessly, to a user control device 28. The user control device 28 may be configured to receive a user-setting input signal S7 comprising user input indicating a user-desired light setting, for example. Such a setting may thus be supplied to the rule-based controller circuit 26, which in response may control the operating current I_{L} accordingly.

The rule-based controller circuit 26 (or the physical state observer circuit 24) may supply the physical state to the user control device 28 as a physical state output signal S6. The user control device 28 may thus indicate the expected remaining lifetime and/or a minimum dim level, possibly compared to a minimum dim level of a new discharge lamp 16.

Thus, in accordance with the present invention, a discharge lamp control system is proposed which is coupled to a physical state estimator in order to obtain a good lamp-ballast interaction based on the actual lamp operation conditions. The lamp model based state estimator may be combined with any other lamp control circuit and any other control method.

Although detailed embodiments of the present invention are disclosed herein, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the mere fact that certain measures are recited in mutually different dependent claims does not indicate that a combination of these measures cannot be used to advantage.

Further, the terms and phrases used herein are not intended to be limiting; but rather, to provide an understandable description of the invention. The terms “a” or “an”, as used herein, are defined as one or more than one. The term another, as used herein, is defined as at least a second or more. The terms including and/or having, as used herein, are defined as comprising (i.e., open language). The term coupled, as used herein, is defined as connected, although not necessarily directly and not necessarily by means of wires.

1. Method of operating a gas discharge lamp, the method comprising:
providing an operating current to the gas discharge lamp;
determining an operating parameter of the gas discharge lamp;
determining a value of a physical lamp parameter of the gas discharge lamp based on the determined operating parameter;
determining an operating state of the gas discharge lamp using the determined value of the physical lamp parameter and a corresponding model of a physical process of the gas discharge lamp; and
controlling the operating current of the gas discharge lamp based on the determined operating state of the gas discharge lamp.

2. Method according to claim 1, wherein step (e) comprises controlling the operating current based on a user-setting received from a user-control device.

3. Method according to claim 1, wherein the method further comprises supplying the determined operating state to a user-control device.

4. Method according to claim 1, wherein step (c) comprises determining the physical lamp parameter further based on an estimated physical lamp parameter.

5. Method according to claim 1, wherein step (c) comprises determining the physical lamp parameter using a method selected from the group comprising an adaptive algorithm, a run-up tracing method, a Pseudo Random Noise Sequence, PRNS, and any combination thereof.

6. Lamp driver system for operating a gas discharge lamp, the lamp driver system comprising:
a lamp driver circuit for supplying a lamp current to the gas discharge lamp;
a sensing circuit coupled to a lamp terminal for sensing an operating parameter of the gas discharge lamp;
a control system coupled to the lamp driver circuit for controlling the lamp current and coupled to the sensing circuit for receiving the operating parameter,
wherein the control system is configured for determining a physical lamp parameter based on the received operating parameter and for determining a lamp operating state using the determined physical lamp parameter and a corresponding model of a physical process of the gas discharge lamp; and for controlling the lamp current based on the determined operating state of the gas discharge lamp.

7. Lamp driver system according to claim 6, wherein the lamp driver system further comprises a user-control device coupled to the control system for supplying a user-setting to the control system.

8. Lamp driver system according to claim 6, wherein the lamp driver system further comprises a user-control device coupled to the control system, wherein the control system is configured to supply thye lamp operating state to the user-control device.

9. Lamp driver system according to claim 6, wherein the control system is configured to determine the physical lamp parameter further based on an estimated physical lamp parameter.

10. Lamp driver system according to claim 6, wherein the control system is configured to determine the physical lamp parameter using a method selected from the group comprising an adaptive algorithm, a run-up tracing method, a Pseudo Random Noise Sequence, PRNS, and combinations thereof.

11. Lamp driver system according to claim 6, wherein the control system comprises a microcontroller and a memory coupled to the microcontroller, the memory comprising microcontroller executable instructions for instructing the microcontroller to determine the physical lamp parameter based on the received operating parameter and to determine the lamp operating state using the determined physical lamp parameter and using the corresponding model of the physical process of the gas discharge lamp.

12. Lamp assembly comprising a lamp driver circuit according to claim 6 and a gas discharge lamp coupled to the lamp terminal, the gas discharge lamp in particular being a Ultra High Pressure, UHT, gas discharge lamp or a high intensity discharge, HID, lamp.

13. Computer program comprising microcontroller executable instructions for instructing the microcontroller to perform at least one of steps (c) and (d) of the method according to claim 1.
